(19) United States
(12) Patent Application Publication
(10) Pub. No.: US 2026/0350618 A1
(43) Pub. Date: Nov. 5, 2026

(54) Technologies for Detecting Potential Money Laundering for Remote Deposits

(71) Applicant: The PNC Financial Services Group, Inc., Pittsburgh, PA (US)

(72) Inventors: David R. Adams, Pittsburgh, PA (US); Lucas Lafferty, Staten Island, NY (US); Kendall Wall, Birmingham, AL (US); Jacob Harold Schoifet, New York, NY (US); Marc Piekarski, Pittsburgh, PA (US)

(21) Appl. No.: 19/196,274

(22) Filed: May 1, 2025

Related U.S. Application Data
(60) Provisional application No. 63/640,399, filed on Apr. 30, 2024.

(51) Int. Cl. G06Q 20/40

(52) U.S. Cl. CPC G06Q 20/4016

(57) ABSTRACT

Technologies for detecting potential money laundering for remote deposits include a compute device. The compute device may include circuitry configured to obtain deposit data indicative of deposits submitted remotely by one or more customers of a financial institution. The circuitry may also be configured to apply a set of tests with corresponding thresholds to the deposit data to detect one or more scenarios indicative of a corresponding alert condition associated with potential money laundering. Additionally, the circuitry may be configured to provide, in response to a determination that an alert condition has been detected, an alert indicative of the detected alert condition.

### RELATED APPLICATIONS

This application claims the benefit of U.S. Provisional Application No. 63/640,399 filed Apr. 30, 2024 for “Technologies for Detecting Potential Money Laundering for Remote Deposits,” which is hereby incorporated by reference in its entirety.

### BACKGROUND

Financial institutions (e.g., banks) have an obligation to maintain compliance with a variety of regulations, including regulations that pertain to safeguarding against money laundering. With increasing computerization of financial transactions, banking has become more complex and financial transactions that were previously impossible have become available. However, measures that were traditionally utilized to comply with banking regulations for in-person interactions are not practicable for financial transactions that have become possible only through computer networks.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for detecting potential money laundering for remote deposits;

FIG. 2 is a simplified block diagram of at least one embodiment of a compute device of the system of FIG. 1;

FIGS. 3-6 are simplified block diagrams of at least one embodiment of a method for detecting potential money laundering for remote deposits that may be executed by the system of FIG. 1; and

FIG. 7 is a high level diagram of at least one embodiment of the method for detecting potential money laundering that may be performed with the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

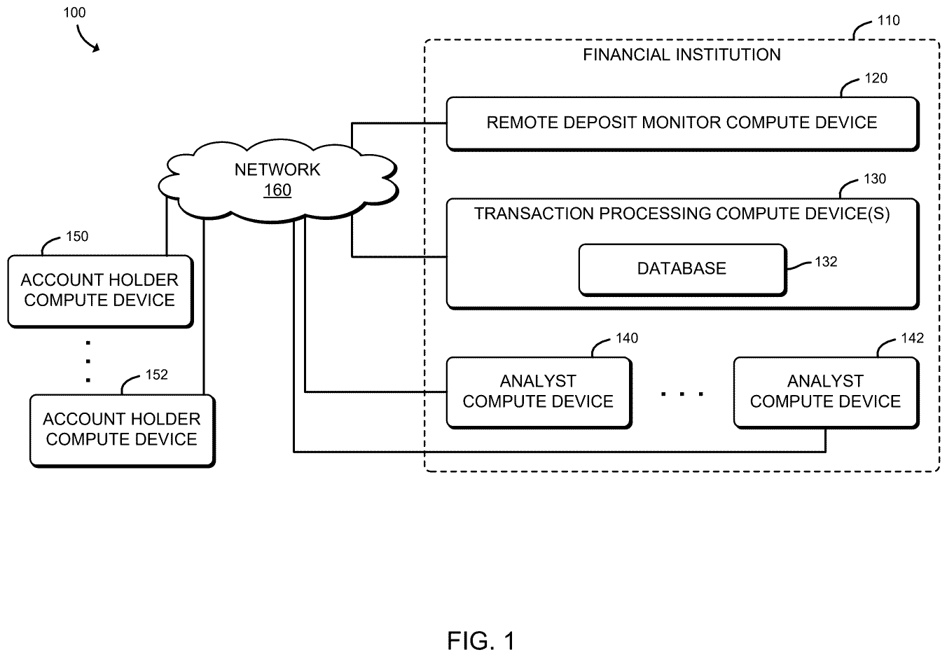

Referring now to FIG. 1, a system 100 for detecting potential money laundering for remote deposits includes, in the illustrative embodiment, a remote deposit monitor compute device 120 communicatively coupled to a set of one or more transaction processing compute devices 130 of a financial institution (e.g., a bank) 110. In operation, account holder compute devices 150, 152 may remotely (e.g., electronically) deposit funds (e.g., money) into financial accounts (e.g., deposit accounts such as checking or savings accounts) held by customers (e.g., business customers, such as companies or other organizations) of the financial institution 110, by transmitting corresponding data indicative of the amounts of money to deposit, an identifier of the corresponding financial account, and related data to the transaction processing compute devices 130. In some embodiments, the data transmitted by the account holder compute devices 150, 152 may incorporate or be based on scanned images of checks or other instruments to transfer funds to an account (e.g., an account of the account holder associated with the corresponding account holder compute device 150, 152). In turn, the transaction processing compute device 130, in operation, may process the corresponding financial transactions, update the associated balances of the financial accounts, and store a record of the financial transactions (e.g., deposits) in a database 132 (e.g., a system of record).

The remote deposit monitor compute device 120, in operation, may continually analyze sets of data indicative of the financial transactions processed by the transaction processing compute devices 130 to determine whether the financial transactions (e.g., remote deposits) submitted by any of the account holders (e.g., customers) are indicative of potential money laundering. In doing so, and as described in more detail herein, the remote deposit monitor compute device 120 applies a set of tests with varying thresholds, for numbers of transactions, sizes (e.g., monetary amounts) of the transactions, for different time periods, to identify the presence of particular scenarios by which money laundering may occur. In response to a determination that a scenario may be present (e.g., an alert condition), the remote deposit monitor compute device 120 may provide an alert indicative of the underlying financial transaction data to an analyst compute device 140, 142 (e.g., operated by a human analyst) for further review (e.g., to determine whether the financial transactions are indeed indicative of money laundering). In operation, the remote deposit monitor compute device 120 may apply thresholds that are determined based on a vast set of information, including historical deposits made by customers of the financial institution over varying time periods, information obtained from the customers during an onboarding process (e.g., a Know Your Customer (KYC) due diligence process), risk level data that may be produced by a risk scoring model, and/or other factors as described herein. As such, and unlike conventional systems, the system 100 enables the financial institution 110 to efficiently identify potential risks to regulatory compliance resulting from electronically-initiated financial transactions (e.g., remote deposits) that were not possible in traditional in-person banking environments.

While a relatively small number of compute devices 120, 130, 140, 142, 150, 152 are shown in FIG. 1 for simplicity and clarity, it should be understood that the number of compute devices, in practice, may range in the tens, hundreds, thousands, or more. Likewise, it should be understood that the compute devices 120, 130, 140, 142, 150, 152 may be distributed differently or perform different roles than the configuration shown in FIG. 1. Further, though shown as separate compute devices 120, 130, 140, 142, 150, 152 in some embodiments, the functionality of one or more of the compute devices 120, 130, 140, 142, 150, 152 may be combined into fewer compute devices (the remote deposit monitor compute device 120 may be combined with the transaction processing compute device(s) 130) and/or distributed across more compute devices than those shown in FIG. 1 (e.g., remote deposit monitor compute device 120 may comprise multiple compute devices and/or the transaction processing compute devices 130 may comprise any number of compute devices).

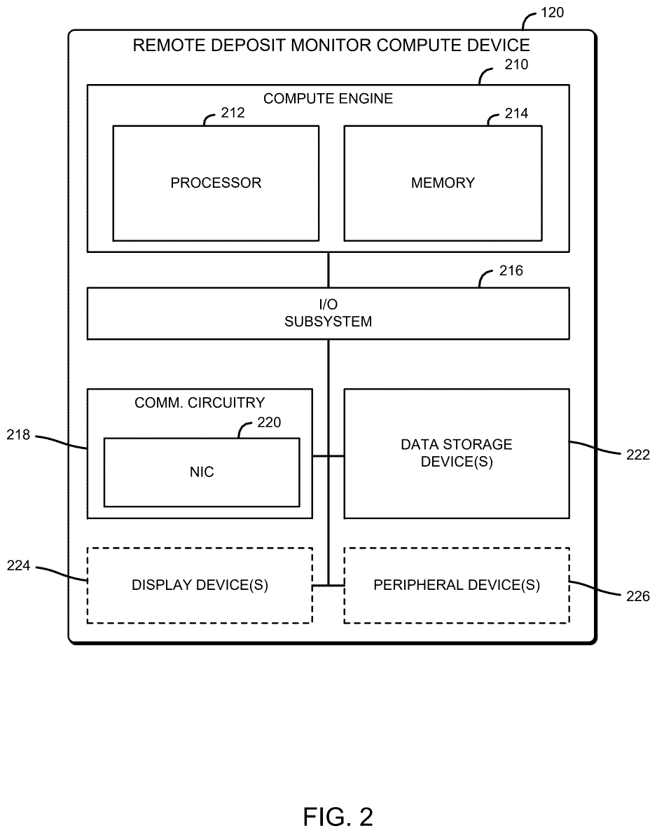

Referring now to FIG. 2, the illustrative remote deposit monitor compute device 120 includes a compute engine 210, an input/output (I/O) subsystem 216, communication circuitry 218, and one or more data storage devices 222. In some embodiments, the remote deposit monitor compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the remote deposit monitor compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as deposit data, threshold data, applications, libraries, and drivers.

The compute engine 210 is communicatively coupled to other components of the remote deposit monitor compute device 120 via the I/O subsystem 216, which may be embodied as circuitry and/or components to facilitate input/output operations with the compute engine 210 (e.g., with the processor 212 and the main memory 214) and other components of the remote deposit monitor compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the remote deposit monitor compute device 120, into the compute engine 210.

The communication circuitry 218 may be embodied as any communication circuit, device, or collection thereof, capable of enabling communications over a network between the remote deposit monitor compute device 120 and another device (e.g., a compute device 130, 140, 142, 150, 152, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the remote deposit monitor compute device 120 to connect with another compute device (e.g., a compute device 130, 140, 142, 150, 152, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the remote deposit monitor compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the remote deposit monitor compute device 120 are housed in a single unit. However, in other embodiments, the components may be in separate housings, in separate racks of a data center, and/or spread across multiple data centers or other facilities. The compute devices 130, 140, 142, 150, 152 may have components similar to those described in FIG. 2 with reference to the remote deposit monitor compute device 120. The description of those components of the remote deposit monitor compute device 120 is equally applicable to the description of components of the compute devices 130, 140, 142, 150, 152. Further, it should be appreciated that any of the devices 120, 130, 140, 142, 150, 152 may include other components, sub-components, and devices commonly found in a computing device, which are not discussed above in reference to the remote deposit monitor compute device 120 and not discussed herein for clarity of the description.

In the illustrative embodiment, the compute devices 120, 130, 140, 142, 150, 152, are in communication via a network 160, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

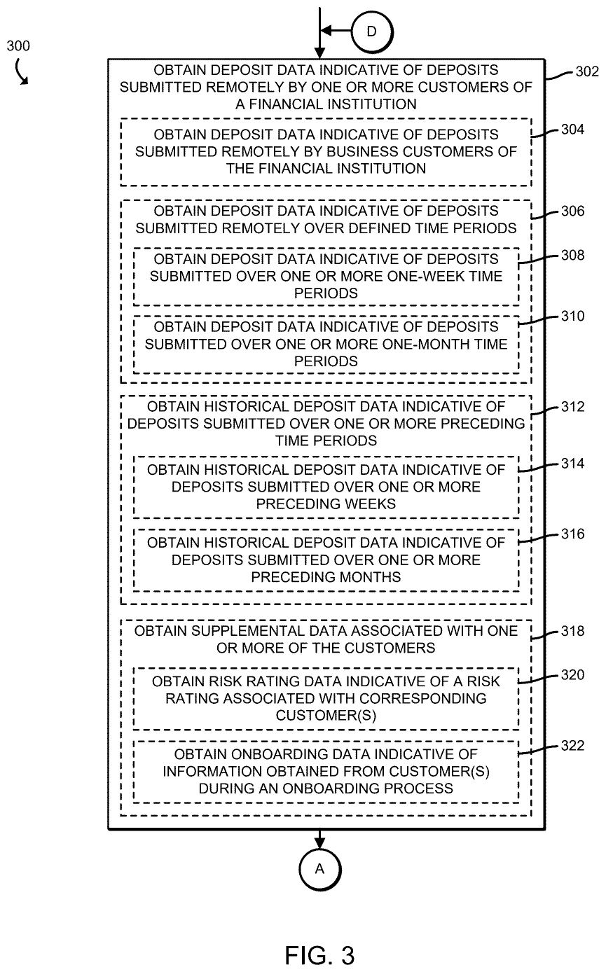

Referring now to FIG. 3, the system 100, and specifically, the remote deposit monitor compute device 120, in the illustrative embodiment, may perform a method 300 for detecting potential money laundering associated with remote deposits, to enable the financial institution 110 to maintain compliance with banking regulations. The method 300 begins with block 302 in which the remote deposit monitor compute device 120 obtains (e.g., from the database 132, such as through one or more corresponding requests to the transaction processing compute devices 130), deposit data indicative of deposits submitted remotely (e.g., from the account holder compute devices 150, 152) by one or more customers of a financial institution (e.g., the financial institution 110). As indicated in block 304, the remote deposit monitor compute device 120, in the illustrative embodiment, obtains deposit data indicative of deposits submitted remotely by business customers (e.g., companies, organizations, etc.) of the financial institution 110. As indicated in block 306, the remote deposit monitor compute device 120 may obtain deposit data that is indicative of deposits submitted remotely over certain defined time periods. For example, and as indicated in block 308, the remote deposit monitor compute device 120 may obtain deposit data indicative of deposits submitted over one or more one-week time periods. The remote deposit monitor compute device 120 may also obtain deposit data indicative of deposits submitted over one or more one-month time periods, as indicated in block 310.

The remote deposit monitor compute device 120 may obtain historical data (e.g., from the database 132) indicative of deposits submitted over one or more preceding time periods (e.g., prior to the time periods associated with block 306), as indicated in block 312. In doing so, the remote deposit monitor compute device 120 may obtain historical deposit data indicative of deposits submitted over one or more preceding weeks, as indicated in block 314 and/or one or more preceding months, as indicated in block 316. In some embodiments, the remote deposit monitor compute device 120 may obtain supplemental data associated with one or more of the customers (e.g., data other than the records of remote deposits made by the customers), as indicated in block 318. For example, in some embodiments, the remote deposit monitor compute device 120 may obtain risk rating data, which may be embodied as any data indicative of a risk rating (e.g., a degree of risk, such as string containing “high”, “medium”, or “low”, or a corresponding numerical value) associated with one or more of the customers, as indicated in block 320. The remote deposit monitor compute device 120 may obtain onboarding data, which may be embodied as any data indicative of information obtained from the customers during an onboarding process (e.g., during a due diligence process, such as Know Your Customer (KYC), performed by the financial institution for each customer as a prerequisite for enrolling each of them as an account holder).

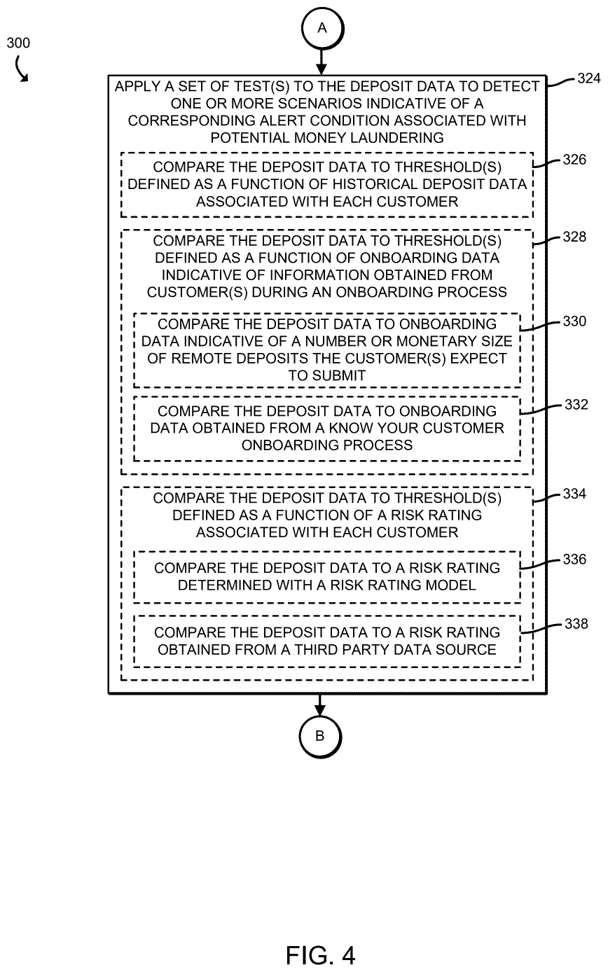

Referring now to FIG. 4, in block 324, in the illustrative embodiment, the remote deposit monitor compute device 120 applies a set of one or more tests to the deposit data (obtained in block 302) to detect one or more scenarios. The scenarios are defined to be indicative of a corresponding alert condition. That is, the scenarios are defined to be indicative of grounds for generating an alert that money laundering may have occurred. In doing so, the remote deposit monitor compute device 120 may compare the deposit data to one or more thresholds that are defined as a function of historical deposit data (e.g., the historical deposit data from block 312) associated with each customer, as indicated in block 326. That is, each threshold may be based on an average number (e.g., volume) or average size (e.g., monetary value) of deposits remotely submitted by the corresponding customer over a defined time period (e.g., a defined number of one-month periods in the past, a defined number of one-week periods in the past, etc.), a range in the number or size of the deposits, or other statistics based on the historical deposit data. As indicated in block 328, remote deposit monitor compute device 120 may compare the deposit data to one or more thresholds defined as a function of onboarding data indicative of information obtained from the one or more customers during an onboarding process (e.g., the onboarding data from block 322). In doing so, and as indicated in block 330, the remote deposit monitor compute device 120 may compare the deposit data to onboarding data indicative of a number or monetary size of remote deposits each corresponding customer expects to submit (e.g., over a defined time period, such as per week or per month). As indicated in block 332, the remote deposit monitor compute device 120 may compare the deposit data to onboarding data that was obtained from a Know Your Customer onboarding process (e.g., the information regarding expected deposits may be based on information provided by the corresponding customer for the onboarding process).

Still referring to FIG. 4, the remote deposit monitor compute device 120 may compare the deposit data to one or more thresholds defined as a function of a risk rating associated with each customer (e.g., based on the risk rating data obtained in block 320), as indicated in block 334. That is, the remote deposit monitor compute device 120 may vary the thresholds as a function of a risk rating of each customer, such that the remote deposit monitor compute device 120 may afford a customer with a lower risk rating more variation in their number or size of remote deposits over a given time period (e.g., as compared to their historical average) before meeting or exceeding (e.g., satisfying) the corresponding threshold, as compared to a customer with a higher risk rating. The remote deposit monitor compute device 120 may compare the deposit data to a risk rating that was determined with a risk rating model (e.g., executed by the remote deposit monitor compute device 120 or another compute device of the financial institution 110, based on one or more characteristics of each user), as indicated in block 336. Alternatively, the remote deposit monitor compute device 120 may compare the deposit data to a risk rating obtained from a third party data source (e.g., a third party that specializes in assigning a risk rating to a customer based on corresponding research), as indicated in block 338.

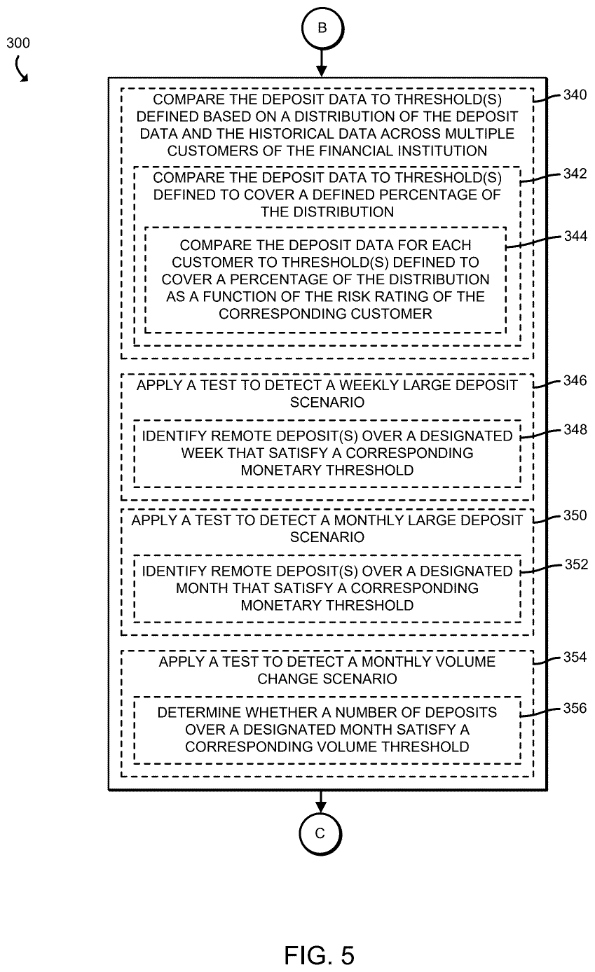

Referring now to FIG. 5, the remote deposit monitor compute device 120 may compare the deposit data to one or more thresholds defined based on a distribution of the deposit data and the historical data across multiple customers of the financial institution 110, as indicated in block 340. In doing so, the remote deposit monitor compute device 120 may compare the deposit data to one or more thresholds defined to cover a defined percentage of the distribution, as indicated in block 342. That is, over a distribution of variation in volume or monetary sizes of remote deposits made by customers, the thresholds may be defined to capture the 10% most extreme cases (e.g., variations large enough to fall within the top 10% of the distribution). As indicated in block 344, the remote deposit monitor compute device 120 may compare the deposit data for each customer to one or more thresholds that are defined to cover a percentage of the distribution that is defined as a function of the risk rating of the customer in question. That is, continuing the example from block 342, the remote deposit monitor compute device 120 may apply a threshold associated with the top 10% of the distribution if the customer in question has a medium risk rating, but may adjust that threshold up or down in relation to the risk rating of the customer (e.g., applying a threshold associated with the top 20% of the distribution if the customer has a high risk rating or applying a threshold associated with the top 5% of the distribution if the customer has a low risk rating).

Still referring to FIG. 5, the remote deposit monitor compute device 120 may apply a test to detect a weekly large deposit scenario, as indicated in block 346. In doing so, the remote deposit monitor compute device 120 may identify remote deposits over a designated week that satisfy a corresponding monetary threshold (e.g., a threshold that may be defined pursuant to one or more of the operations described above), as indicated in block 348. In the illustrative embodiment, identification of such deposit(s) is indicative of a detection of the corresponding scenario (e.g., the weekly large deposit) for the customer in question, and as such, qualifies as an alert condition. As indicated in block 350, the remote deposit monitor compute device 120 may apply a test to detect a monthly large deposit scenario. In doing so, and as indicated in block 352, the remote deposit monitor compute device 120 may identify one or more remote deposits over a designated month that satisfy a corresponding monetary threshold (e.g., a threshold that may be defined pursuant to one or more of the operations described above, indicative of a monetary size for a remote deposit). The remote deposit monitor compute device 120 may apply a test to detect a monthly volume change scenario, as indicated in block 354. In doing so, the remote deposit monitor compute device 120 may determine whether a number of deposits over a designated month satisfy a corresponding volume threshold (which may be defined according to one or more of the operations described above), as indicated in block 356.

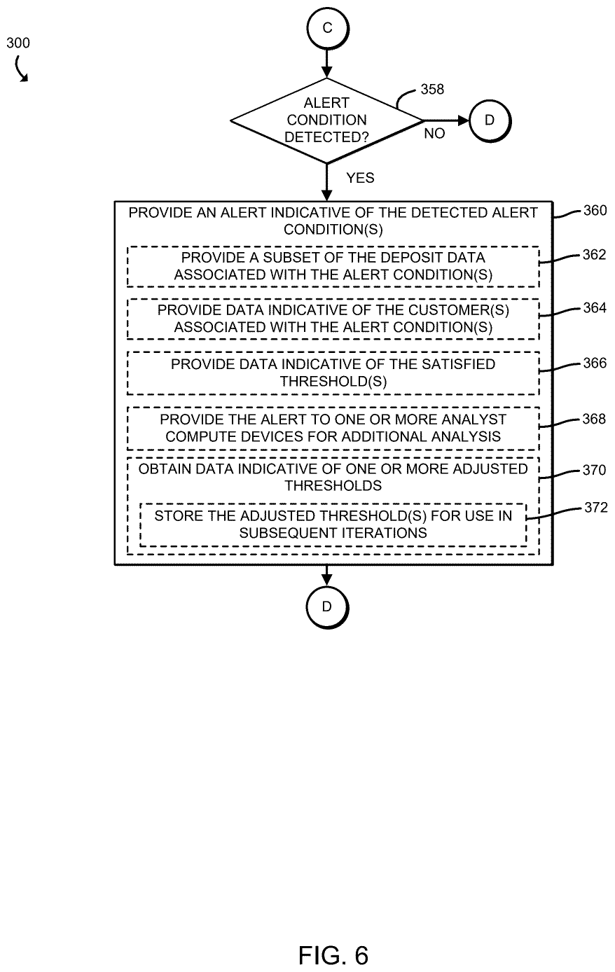

Referring now to FIG. 6, in block 358, the remote deposit monitor compute device 120 determines the subsequent course of action based on whether an alert condition was detected (e.g., whether the remote deposit monitor compute device 120 detected any of the scenarios described with respect to blocks 346, 348, 350, 352, 354, 356). If not, the method 300 may loop back to block 302 of FIG. 3 in which the remote deposit monitor compute device 120 may continue to obtain deposit data (e.g., indicative of additional remote deposits that have been made). Otherwise, if the remote deposit monitor compute device 120 detected an alert condition, the method 300, in the illustrative embodiment, advances to block 360, in which the remote deposit monitor compute device 120 provides an alert indicative of the one or more detected alert conditions (e.g., scenarios). In doing so, the remote deposit monitor compute device 120 may provide, with the alert, a subset of the deposit data, as indicated in block 362. That is, the remote deposit monitor compute device 120 may provide, with the alert, the subset of the deposit data associated with the one or more alert conditions (e.g., scenarios). The remote deposit monitor compute device 120 may provide, with the alert, data indicative of the customer(s) associated with the alert conditions (e.g., detected scenarios), as indicated in block 364. For example, the remote deposit monitor compute device 120 may identify each customer by a code that uniquely identifies the customer (e.g., as a primary key in the database 132) in connection with the alert. As indicated in block 366, the remote deposit monitor compute device 120 may provide data indicative of the satisfied threshold(s) (e.g., the threshold(s) satisfied in connection with one or more of the tests from blocks 346, 348, 350, 352, 354, 356) to assist in human understanding of the reason for the alert condition(s).

Still referring to FIG. 6, the remote deposit monitor compute device 120 may provide the alert to one or more analyst compute devices 140, 142 (e.g., in an email or other message format) for additional analysis (e.g., to confirm whether the remote deposits indeed are indicative of potential money laundering), as indicated in block 368. For continual refinement of the thresholds, the remote deposit monitor compute device 120 may obtain data indicative of one or more adjusted thresholds (e.g., to increase detection accuracy, such as in response to a determination by an analyst that an alert provided by the remote deposit monitor compute device 120 was a false positive), as indicated in block 370. As indicated in block 372, the remote deposit monitor compute device 120 may store any adjusted thresholds for use in subsequent iterations of the method 300. Though the operations of the method 300 are described in a particular sequence, it should be understood that in other embodiments, operations may be performed in a different order and/or in parallel (e.g., obtaining additional deposit data while determining whether already-obtained deposit data is indicative of an alert condition).

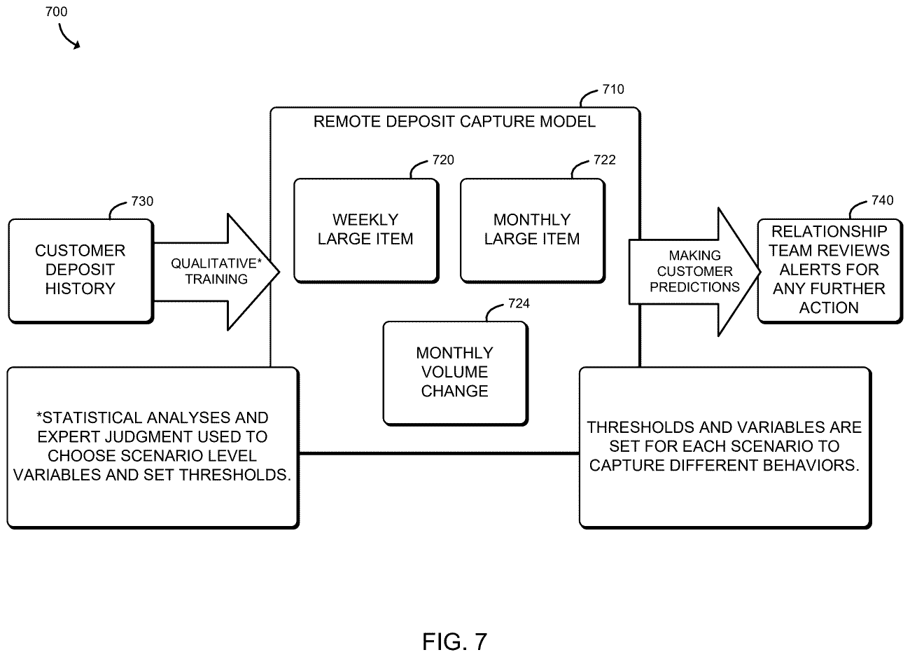

A high level diagram 700 of at least one embodiment of operations, data, and models that may be involved in the performance of the method 300 is provided in FIG. 7. As shown, a remote deposit capture model 710 executed by the remote deposit monitor compute device 120 is trained (e.g., to set thresholds) based, at least in part, on customer deposit history 730 (e.g., from the database 132 of FIG. 1). In the illustrative embodiment, the model 710 includes three tests 720, 722, 724 that vary at least by the lookback window (e.g., period of time) and thresholds applied to the obtained deposit data. The model 710 produces predictions (e.g., alerts) if one or more of the tests 720, 722, 724 identified a corresponding scenario indicative of potential money laundering. The alerts are provided to individuals from a team assigned to review the alerts (e.g., using the analyst compute devices 140, 142), as indicated in block 740, to determine whether the underlying data is indeed indicative of money laundering.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain deposit data indicative of deposits submitted remotely by one or more customers of a financial institution; apply a set of tests with corresponding thresholds to the deposit data to detect one or more scenarios indicative of a corresponding alert condition associated with potential money laundering; and provide, in response to a determination that an alert condition has been detected, an alert indicative of the detected alert condition.

Example 2 includes the subject matter of Example 1, and wherein to obtain deposit data comprises to obtain deposit data indicative of deposits submitted remotely by business customers of the financial institution.

Example 3 includes the subject matter of any of Examples 1 and 2, and wherein the circuitry is further configured to obtain supplemental data associated with one or more of the customers.

Example 4 includes the subject matter of any of Examples 1-3, and wherein to obtain supplemental data comprises to obtain risk rating data indicative of a risk rating associated with each of the one or more customers.

Example 5 includes the subject matter of any of Examples 1-4, and wherein to obtain supplemental data comprises to obtain onboarding data indicative of information associated with an onboarding process for each of the one or more customers.

Example 6 includes the subject matter of any of Examples 1-5, and wherein to apply a set of tests comprises to compare the deposit data to one or more thresholds defined as a function of historical deposit data associated with each customer.

Example 7 includes the subject matter of any of Examples 1-6, and wherein to apply a set of tests comprises to compare the deposit data to one or more thresholds defined as a function of onboarding data indicative of information obtained from the one or more customers during an onboarding process.

Example 8 includes the subject matter of any of Examples 1-7, and wherein to compare the deposit data to one or more thresholds defined as a function of onboarding data comprises to compare the deposit data to onboarding data indicative of a number or monetary size of remote deposits the one or more customers have indicated an expectation to submit.

Example 9 includes the subject matter of any of Examples 1-8, and wherein to compare the deposit data to one or more thresholds defined as a function of onboarding data comprises to compare the deposit data to onboarding data obtained from a know your customer onboarding process.

Example 10 includes the subject matter of any of Examples 1-9, and wherein to apply a set of tests with corresponding thresholds comprises to compare the deposit data to one or more thresholds defined as a function of a risk rating associated with each customer.

Example 11 includes the subject matter of any of Examples 1-10, and wherein to apply a set of tests with corresponding thresholds comprises to compare the deposit data to thresholds defined based on a distribution of the deposit data and historical data across multiple customers of the financial institution.

Example 12 includes the subject matter of any of Examples 1-11, and wherein to compare the deposit data to thresholds comprises to compare the deposit data to thresholds defined to cover a defined percentage of the distribution.

Example 13 includes the subject matter of any of Examples 1-12, and wherein to compare the deposit data to thresholds defined to cover a defined percentage of the distribution comprises to compare the deposit data for each customer to thresholds defined to cover a percentage of the distribution as a function of a risk rating associated with the corresponding customer.

Example 14 includes the subject matter of any of Examples 1-13, and wherein to apply a set of tests comprises to apply a test to detect a weekly large deposit scenario.

Example 15 includes the subject matter of any of Examples 1-14, and wherein to apply a test to detect a weekly large deposit scenario comprises to identify one or more remote deposits over a designated week that satisfy a corresponding monetary threshold.

Example 16 includes the subject matter of any of Examples 1-15, and wherein to apply a set of tests comprises to apply a test to detect a monthly large deposit scenario.

Example 17 includes the subject matter of any of Examples 1-16, and wherein to apply a test to detect a monthly large deposit scenario comprises to identify one or more remote deposits over a designated month that satisfy a corresponding monetary threshold.

Example 18 includes the subject matter of any of Examples 1-17, and wherein to apply a set of tests comprises to apply a test to detect a monthly volume change scenario.

Example 19 includes the subject matter of any of Examples 1-18, and wherein to apply a test to detect a monthly volume change scenario comprises to determine whether a number of deposits over a designated month satisfy a corresponding volume threshold.

Example 20 includes the subject matter of any of Examples 1-19, and wherein to provide an alert comprises to provide a subset of the deposit data associated with the alert condition.

Example 21 includes the subject matter of any of Examples 1-20, and wherein to provide an alert comprises to provide data indicative of the one or more customers associated with the alert condition.

Example 22 includes the subject matter of any of Examples 1-21, and wherein to provide an alert comprises to provide data indicative of one or more thresholds satisfied by the deposit data.

Example 23 includes the subject matter of any of Examples 1-22, and wherein to provide an alert comprises to provide the alert to one or more analyst compute devices for additional analysis.

Example 24 includes the subject matter of any of Examples 1-23, and wherein the circuitry is further configured to obtain data indicative of one or more adjusted thresholds; and store the one or more adjusted thresholds for use in the set of tests.

Example 25 includes the subject matter of any of Examples 1-24, and wherein to obtain deposit data comprises to obtain deposit data indicative of deposits submitted remotely over one or more one-week time periods.

Example 26 includes the subject matter of any of Examples 1-25, and wherein to obtain deposit data comprises to obtain deposit data indicative of deposits submitted remotely over one or more one-month time periods.

Example 27 includes the subject matter of any of Examples 1-26, and wherein the circuitry is further configured to obtain historical deposit data indicative of deposits submitted over one or more preceding weeks or months.

Example 28 includes a method comprising obtaining, by a compute device, deposit data indicative of deposits submitted remotely by one or more customers of a financial institution; applying, by the compute device, a set of tests with corresponding thresholds to the deposit data to detect one or more scenarios indicative of a corresponding alert condition associated with potential money laundering; and providing, by the compute device and in response to a determination that an alert condition has been detected, an alert indicative of the detected alert condition.

Example 29 includes the subject matter of Example 28, and wherein obtaining deposit data comprises obtaining deposit data indicative of deposits submitted remotely by business customers of the financial institution.

Example 30 includes the subject matter of any of Examples 28 and 29, and further including obtaining, by the compute device, supplemental data associated with one or more of the customers.

Example 31 includes the subject matter of any of Examples 28-30, and wherein obtaining supplemental data comprises obtaining risk rating data indicative of a risk rating associated with each of the one or more customers.

Example 32 includes the subject matter of any of Examples 28-31, and wherein obtaining supplemental data comprises obtaining onboarding data indicative of information associated with an onboarding process for each of the one or more customers.

Example 33 includes the subject matter of any of Examples 28-32, and wherein applying a set of tests comprises comparing the deposit data to one or more thresholds defined as a function of historical deposit data associated with each customer.

Example 34 includes the subject matter of any of Examples 28-33, and wherein applying a set of tests comprises comparing the deposit data to one or more thresholds defined as a function of onboarding data indicative of information obtained from the one or more customers during an onboarding process.

Example 35 includes the subject matter of any of Examples 28-34, and wherein comparing the deposit data to one or more thresholds defined as a function of onboarding data comprises comparing the deposit data to onboarding data indicative of a number or monetary size of remote deposits the one or more customers have indicated an expectation to submit.

Example 36 includes the subject matter of any of Examples 28-35, and wherein comparing the deposit data to one or more thresholds defined as a function of onboarding data comprises comparing the deposit data to onboarding data obtained from a know your customer onboarding process.

Example 37 includes the subject matter of any of Examples 28-36, and wherein applying a set of tests with corresponding thresholds comprises comparing the deposit data to one or more thresholds defined as a function of a risk rating associated with each customer.

Example 38 includes the subject matter of any of Examples 28-37, and wherein applying a set of tests with corresponding thresholds comprises comparing the deposit data to thresholds defined based on a distribution of the deposit data and historical data across multiple customers of the financial institution.

Example 39 includes the subject matter of any of Examples 28-38, and wherein comparing the deposit data to thresholds comprises comparing the deposit data to thresholds defined to cover a defined percentage of the distribution.

Example 40 includes the subject matter of any of Examples 28-39, and wherein comparing the deposit data to thresholds defined to cover a defined percentage of the distribution comprises comparing the deposit data for each customer to thresholds defined to cover a percentage of the distribution as a function of a risk rating associated with the corresponding customer.

Example 41 includes the subject matter of any of Examples 28-40, and wherein applying a set of tests comprises applying a test to detect a weekly large deposit scenario.

Example 42 includes the subject matter of any of Examples 28-41, and wherein applying a test to detect a weekly large deposit scenario comprises identifying one or more remote deposits over a designated week that satisfy a corresponding monetary threshold.

Example 43 includes the subject matter of any of Examples 28-42, and wherein applying a set of tests comprises applying a test to detect a monthly large deposit scenario.

Example 44 includes the subject matter of any of Examples 28-43, and wherein applying a test to detect a monthly large deposit scenario comprises identifying one or more remote deposits over a designated month that satisfy a corresponding monetary threshold.

Example 45 includes the subject matter of any of Examples 28-44, and wherein applying a set of tests comprises applying a test to detect a monthly volume change scenario.

Example 46 includes the subject matter of any of Examples 28-45, and wherein applying a test to detect a monthly volume change scenario comprises determining whether a number of deposits over a designated month satisfy a corresponding volume threshold.

Example 47 includes the subject matter of any of Examples 28-46, and wherein providing an alert comprises providing a subset of the deposit data associated with the alert condition.

Example 48 includes the subject matter of any of Examples 28-47, and wherein providing an alert comprises providing data indicative of the one or more customers associated with the alert condition.

Example 49 includes the subject matter of any of Examples 28-48, and wherein providing an alert comprises providing data indicative of one or more thresholds satisfied by the deposit data.

Example 50 includes the subject matter of any of Examples 28-49, and wherein providing an alert comprises providing the alert to one or more analyst compute devices for additional analysis.

Example 51 includes the subject matter of any of Examples 28-50, and further including obtaining, by the compute device, data indicative of one or more adjusted thresholds; and storing, by the compute device, the one or more adjusted thresholds for use in the set of tests.

Example 52 includes the subject matter of any of Examples 28-51, and wherein obtaining deposit data comprises obtaining deposit data indicative of deposits submitted remotely over one or more one-week time periods.

Example 53 includes the subject matter of any of Examples 28-52, and wherein obtaining deposit data comprises obtaining deposit data indicative of deposits submitted remotely over one or more one-month time periods.

Example 54 includes the subject matter of any of Examples 28-53, and further including obtaining, by the compute device, historical deposit data indicative of deposits submitted over one or more preceding weeks or months.

Example 55 includes one or more machine-readable storage media comprising a plurality of instructions stored thereon that, in response to being executed, cause a compute device to obtain deposit data indicative of deposits submitted remotely by one or more customers of a financial institution; apply a set of tests with corresponding thresholds to the deposit data to detect one or more scenarios indicative of a corresponding alert condition associated with potential money laundering; and provide, in response to a determination that an alert condition has been detected, an alert indicative of the detected alert condition.

Example 56 includes the subject matter of Example 55, and wherein to obtain deposit data comprises to obtain deposit data indicative of deposits submitted remotely by business customers of the financial institution.

Example 57 includes the subject matter of any of Examples 55 and 56, and wherein the instructions additionally cause the compute device to obtain supplemental data associated with one or more of the customers.

Example 58 includes the subject matter of any of Examples 55-57, and wherein to obtain supplemental data comprises to obtain risk rating data indicative of a risk rating associated with each of the one or more customers.

Example 59 includes the subject matter of any of Examples 55-58, and wherein to obtain supplemental data comprises to obtain onboarding data indicative of information associated with an onboarding process for each of the one or more customers.

Example 60 includes the subject matter of any of Examples 55-59, and wherein to apply a set of tests comprises to compare the deposit data to one or more thresholds defined as a function of historical deposit data associated with each customer.

Example 61 includes the subject matter of any of Examples 55-60, and wherein to apply a set of tests comprises to compare the deposit data to one or more thresholds defined as a function of onboarding data indicative of information obtained from the one or more customers during an onboarding process.

Example 62 includes the subject matter of any of Examples 55-61, and wherein to compare the deposit data to one or more thresholds defined as a function of onboarding data comprises to compare the deposit data to onboarding data indicative of a number or monetary size of remote deposits the one or more customers have indicated an expectation to submit.

Example 63 includes the subject matter of any of Examples 55-62, and wherein to compare the deposit data to one or more thresholds defined as a function of onboarding data comprises to compare the deposit data to onboarding data obtained from a know your customer onboarding process.

Example 64 includes the subject matter of any of Examples 55-63, and wherein to apply a set of tests with corresponding thresholds comprises to compare the deposit data to one or more thresholds defined as a function of a risk rating associated with each customer.

Example 65 includes the subject matter of any of Examples 55-64, and wherein to apply a set of tests with corresponding thresholds comprises to compare the deposit data to thresholds defined based on a distribution of the deposit data and historical data across multiple customers of the financial institution.

Example 66 includes the subject matter of any of Examples 55-65, and wherein to compare the deposit data to thresholds comprises to compare the deposit data to thresholds defined to cover a defined percentage of the distribution.

Example 67 includes the subject matter of any of Examples 55-66, and wherein to compare the deposit data to thresholds defined to cover a defined percentage of the distribution comprises to compare the deposit data for each customer to thresholds defined to cover a percentage of the distribution as a function of a risk rating associated with the corresponding customer.

Example 68 includes the subject matter of any of Examples 55-67, and wherein to apply a set of tests comprises to apply a test to detect a weekly large deposit scenario.

Example 69 includes the subject matter of any of Examples 55-68, and wherein to apply a test to detect a weekly large deposit scenario comprises to identify one or more remote deposits over a designated week that satisfy a corresponding monetary threshold.

Example 70 includes the subject matter of any of Examples 55-69, and wherein to apply a set of tests comprises to apply a test to detect a monthly large deposit scenario.

Example 71 includes the subject matter of any of Examples 55-70, and wherein to apply a test to detect a monthly large deposit scenario comprises to identify one or more remote deposits over a designated month that satisfy a corresponding monetary threshold.

Example 72 includes the subject matter of any of Examples 55-71, and wherein to apply a set of tests comprises to apply a test to detect a monthly volume change scenario.

Example 73 includes the subject matter of any of Examples 55-72, and wherein to apply a test to detect a monthly volume change scenario comprises to determine whether a number of deposits over a designated month satisfy a corresponding volume threshold.

Example 74 includes the subject matter of any of Examples 55-73, and wherein to provide an alert comprises to provide a subset of the deposit data associated with the alert condition.

Example 75 includes the subject matter of any of Examples 55-74, and wherein to provide an alert comprises to provide data indicative of the one or more customers associated with the alert condition.

Example 76 includes the subject matter of any of Examples 55-75, and wherein to provide an alert comprises to provide data indicative of one or more thresholds satisfied by the deposit data.

Example 77 includes the subject matter of any of Examples 55-76, and wherein to provide an alert comprises to provide the alert to one or more analyst compute devices for additional analysis.

Example 78 includes the subject matter of any of Examples 55-77, and wherein the instructions additionally cause the compute device to obtain data indicative of one or more adjusted thresholds; and store the one or more adjusted thresholds for use in the set of tests.

Example 79 includes the subject matter of any of Examples 55-78, and wherein to obtain deposit data comprises to obtain deposit data indicative of deposits submitted remotely over one or more one-week time periods.

Example 80 includes the subject matter of any of Examples 55-79, and wherein to obtain deposit data comprises to obtain deposit data indicative of deposits submitted remotely over one or more one-month time periods.

Example 81 includes the subject matter of any of Examples 55-80, and wherein the instructions additionally cause the compute device to obtain historical deposit data indicative of deposits submitted over one or more preceding weeks or months.

1. A compute device comprising:
circuitry configured to:
obtain deposit data indicative of deposits submitted remotely by one or more customers of a financial institution;
apply a set of tests with corresponding thresholds to the deposit data to detect one or more scenarios indicative of a corresponding alert condition associated with potential money laundering; and
provide, in response to a determination that an alert condition has been detected, an alert indicative of the detected alert condition.

2. The compute device of claim 1, wherein the circuitry is further configured to obtain supplemental data associated with one or more of the customers comprising (i) to obtain risk rating data indicative of a risk rating associated with each of the one or more customers and/or (ii) to obtain onboarding data indicative of information associated with an onboarding process for each of the one or more customers.

3. The compute device of claim 1, wherein to apply a set of tests comprises to compare the deposit data to one or more thresholds defined as a function of (i) historical deposit data associated with each customer; and/or (ii) onboarding data indicative of information obtained from the one or more customers during an onboarding process.

4. The compute device of claim 3, wherein to compare the deposit data to one or more thresholds defined as a function of onboarding data comprises to compare the deposit data to onboarding data (i) indicative of a number or monetary size of remote deposits the one or more customers have indicated an expectation to submit; and/or (ii) obtained from a know your customer onboarding process.

5. The compute device of claim 1, wherein to apply a set of tests with corresponding thresholds comprises to compare the deposit data to thresholds defined based on a distribution of the deposit data and historical data across multiple customers of the financial institution.

6. The compute device of claim 5, wherein to compare the deposit data to thresholds comprises to compare the deposit data to thresholds defined to cover a defined percentage of the distribution.

7. The compute device of claim 6, wherein to compare the deposit data to thresholds defined to cover a defined percentage of the distribution comprises to compare the deposit data for each customer to thresholds defined to cover a percentage of the distribution as a function of a risk rating associated with the corresponding customer.

8. The compute device of claim 1, wherein to apply a set of tests comprises to apply a test to detect a weekly large deposit scenario by identifying one or more remote deposits over a designated week that satisfy a corresponding monetary threshold.

9. The compute device of claim 1, wherein to apply a set of tests comprises to apply a test to detect a monthly large deposit scenario by identifying one or more remote deposits over a designated month that satisfy a corresponding monetary threshold.

10. The compute device of claim 1, wherein to apply a set of tests comprises to apply a test to detect a monthly volume change scenario by determining whether a number of deposits over a designated month satisfy a corresponding volume threshold.

11. The compute device of claim 1, wherein to provide an alert comprises to provide a subset of the deposit data associated with the alert condition.

12. The compute device of claim 1, wherein to obtain deposit data comprises to obtain deposit data indicative of deposits submitted remotely over one or more one-week time periods.

13. The compute device of claim 1, wherein to obtain deposit data comprises to obtain deposit data indicative of deposits submitted remotely over one or more one-month time periods.

14. A method comprising:
obtaining, by a compute device, deposit data indicative of deposits submitted remotely by one or more customers of a financial institution;
applying, by the compute device, a set of tests with corresponding thresholds to the deposit data to detect one or more scenarios indicative of a corresponding alert condition associated with potential money laundering; and
providing, by the compute device and in response to a determination that an alert condition has been detected, an alert indicative of the detected alert condition.

15. The method of claim 14, further comprising obtaining, by the compute device, supplemental data associated with one or more of the customers comprising (i) obtaining risk rating data indicative of a risk rating associated with each of the one or more customers and/or (ii) obtaining onboarding data indicative of information associated with an onboarding process for each of the one or more customers.

16. The method of claim 14, wherein applying a set of tests comprises to compare the deposit data to one or more thresholds defined as a function of (i) historical deposit data associated with each customer; and/or (ii) onboarding data indicative of information obtained from the one or more customers during an onboarding process.

17. The method of claim 16, wherein comparing the deposit data to one or more thresholds defined as a function of onboarding data comprises comparing the deposit data to onboarding data (i) indicative of a number or monetary size of remote deposits the one or more customers have indicated an expectation to submit; and/or (ii) obtained from a know your customer onboarding process.

18. The method of claim 14, wherein applying a set of tests with corresponding thresholds comprises comparing the deposit data to thresholds defined based on a distribution of the deposit data and historical data across multiple customers of the financial institution.

19. The method of claim 18, wherein comparing the deposit data to thresholds comprises comparing the deposit data to thresholds defined to cover a defined percentage of the distribution.

20. The method of claim 19, wherein comparing the deposit data to thresholds defined to cover a defined percentage of the distribution comprises comparing the deposit data for each customer to thresholds defined to cover a percentage of the distribution as a function of a risk rating associated with the corresponding customer.

21. The method of claim 14, wherein applying a set of tests comprises applying a test to detect a weekly large deposit scenario by identifying one or more remote deposits over a designated week that satisfy a corresponding monetary threshold.

22. The method of claim 14, wherein applying a set of tests comprises applying a test to detect a monthly large deposit scenario by identifying one or more remote deposits over a designated month that satisfy a corresponding monetary threshold.

23. The method of claim 14, wherein applying a set of tests comprises applying a test to detect a monthly volume change scenario by determining whether a number of deposits over a designated month satisfy a corresponding volume threshold.

24. The method of claim 14, wherein providing an alert comprises to provide a subset of the deposit data associated with the alert condition.

25. The method of claim 14, wherein obtaining deposit data comprises obtaining deposit data indicative of deposits submitted remotely over one or more one-week time periods.

26. The method of claim 14, wherein obtaining deposit data comprises obtaining deposit data indicative of deposits submitted remotely over one or more one-month time periods.
